(19) United States
(12) Patent Application Publication
(10) Pub. No.: US 2008/0284665 A1
(43) Pub. Date: Nov. 20, 2008

(54) Antenna to be Used For Communication (Transmitting and/or Receiving) in a Motor Vehicle, Particularly a Passenger Car

(76) Inventors: Markus Pfletschinger, Eningen (DE); Boris Wischniowski, Stuttgart (DE)

Correspondence Address: K.F. ROSS P.C., 5683 RIVERDALE AVENUE, SUITE 203 BOX 900, BRONX, NY, 10471-0900, US

(21) Appl. No.: 11/658,328

(22) PCT Filed: Jun. 23, 2005
(86) PCT No.: PCT/EP2005/006772

§ 371 Date: Jan. 23, 2007

(30) Foreign Application Priority Data
Jul. 24, 2004 (DE) 10 2004 036 453.2

(51) Int. Cl. H01Q 1/32

(52) U.S. Cl. 343/713

(57) ABSTRACT

The invention relates to an antenna (3) which is used for communication purposes (transmission and/or reception) in a motor vehicle (7), particularly in a passenger car. According to the invention, the antenna (3) is arranged inside the vehicle (7) in a place which is protected against crashes, thereby enabling provision of sufficient antenna (3) radiation required for communication purposes, in the event of a crash.

The invention relates to an antenna for use communicating in a vehicle according to the characteristics of the preamble of claim 1.

### TECHNICAL FIELD

Antennas for use communicating in a vehicle are basically known. Such an antenna in the simplest case may be a rod antenna that is attached to the body and receives and/or transmits high-frequency signals. In addition, nowadays integrated antenna systems are available, having electrically conductive structures provided in or on an outer surface of the vehicle, particularly in a rear window or a side window. The signal exchange (reception and/or transmission of high-frequency signals) between the transmitter and/or receiver in the vehicle and the outside transmitter and/or receiver is carried out via these electrically conductive antenna structures. These antenna systems known so far have proven useful in practice, however are associated with certain disadvantages if the vehicle is involved in an accident. For example, it is known today that in the event of a vehicle accident signals are emitted by certain devices inside the vehicle that indicate the vehicle position to the receiver of the signals. By emitting such an emergency call, it can be guaranteed that rescue services receive notification of the position of the vehicle and can take appropriate measures. If the transmission of such an emergency call fails, it may be associated at times with serious disadvantages for the passengers of the vehicle, particularly in the case of severe accidents, because the rescue team cannot be directed to the site of the accident quickly enough. Such an emergency call signal, however, is not transmitted if the antenna structures are provided in the locations known so far. Particularly in the event of an accident, outside surface parts like the rear windows and side windows referred to above are inevitably destroyed, so that the emergency call signal can no longer be sent with the antenna conductor structures provided thereon.

### DESCRIPTION OF THE INVENTION

It is therefore the object of the invention to provide an antenna that is used for use communicating in a vehicle and which guarantees the transmission of an emergency call signal in the event of an accident.

This object is achieved with the characteristics of claim 1.

According to the invention, the antenna (or also a plurality of antennas) is (are) mounted in the vehicle in a crash-protected location that allows the radiation required for the antenna for use communicating. Providing the antenna in an arrangement according to the invention guarantees that in the event of a vehicle accident the antenna is not destroyed, thus allowing an emergency call signal to be sent in case of a crash. Care must be taken that at least one antenna is mounted on the inside of the vehicle such that the radiation of the antenna required for use communicating is still provided.

Possible locations for the crash-protected provision of at least one antenna are all locations inside the passenger compartment in the vicinity of the passengers, particularly the driver of the vehicle. These locations have the advantage that they are secured particularly well for the passengers through special safety precautions (particularly airbags) in the event an accident should take place. Examples of such locations according to the invention are the dashboard, the roof lining, the sun visor, the inside door handle, the seat, the headrest, the interior lining and the armrests, this list not being exhaustive. It is also conceivable to provide a plurality of antennas in several of the above locations.

Furthermore it is conceivable to mount the antenna in a connecting brace between the roof and body of the vehicle, particularly in a C-column. Since particularly in the event that the vehicle is overturned the vehicle roof must absorb the resultant high forces, these connecting braces are made particularly solid and are not destroyed if the vehicle rolls, so that the antenna in a particularly advantageous embodiment can be provided there.

The same applies to a vehicle with removable top (convertible), such a vehicle having the antenna according to the invention in the region of a roll bar. Depending on the severity of the crash, the roll bar extends and thus protects the head region of the passenger, so that this region is also particularly suited for providing the antenna to prevent it from being destroyed in the event of a crash and for being available to send the emergency call signal.

In a further embodiment, the antenna is provided in a mirror (rear-view mirror) inside of the vehicle. This also ensures that at least one antenna is accommodated in a crash-protected location.

In all the locations referred to above and all further conceivable locations available for mounting at least one antenna inside the vehicle interior, where the antennas and the devices connected thereto are set up such that they send emergency call signals, the antenna can fulfill this function as well as further functions. For example, these antennas enable communication inside the vehicle and with devices outside of the vehicle.

The concrete design of the respective antenna is not as important, however care must be taken that it can be installed in the desired installation space (i.e. that the necessary installation space is available) and that it has the required radiation characteristics. The antenna may be tuned to a defined frequency range or have a broad frequency range (multi-band antenna).

### BRIEF DESCRIPTION OF THE FIGURES

Exemplary arrangements of the antenna according to the invention are described hereinafter and explained with reference to the figures, the described locations only being mentioned by way of example and not being exhaustive. Therein:

FIG. 1 is an emergency call antenna in a headrest,

FIG. 2 is an emergency call antenna in a seat,

FIG. 3 is an emergency call antenna in a roof lining,

FIG. 4 is an emergency call antenna on the inside of a C-column of a vehicle.

### EMBODIMENTS OF THE INVENTION

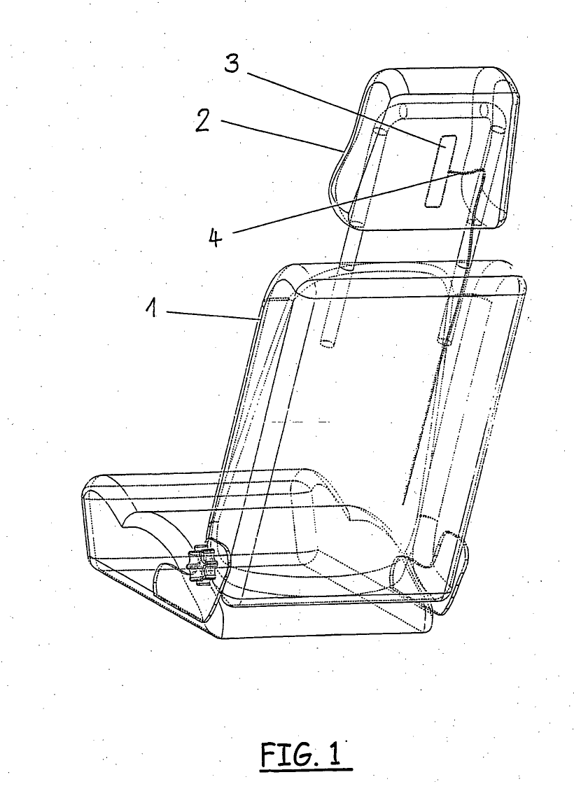

FIG. 1 shows a seat 1 of a vehicle where the backrest of the seat 1 has a headrest 2. At least one emergency call antenna 3 is mounted inside this headrest 2 according to the invention, the headrest 2 being provided in a location inside the vehicle that is crash-protected particularly well. The emergency call antenna 3 is also provided with (schematically illustrated) cabling 4, this cabling 4 transmitting the signals received by or transmitted from the emergency call antenna 3 to the downstream devices that are not shown.

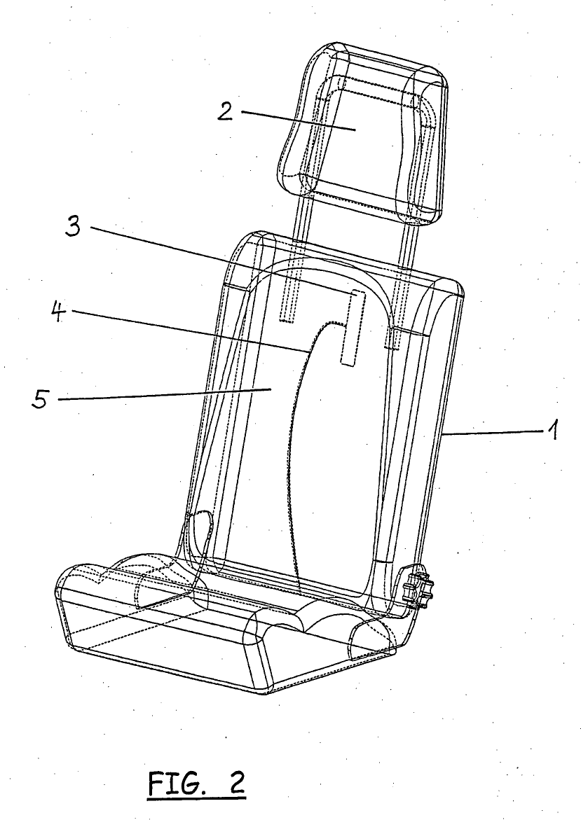

FIG. 2 shows an emergency call antenna 3 with the cabling in a backrest 5 of the seat 1. This also produces the same advantages as the arrangement according to FIG. 1.

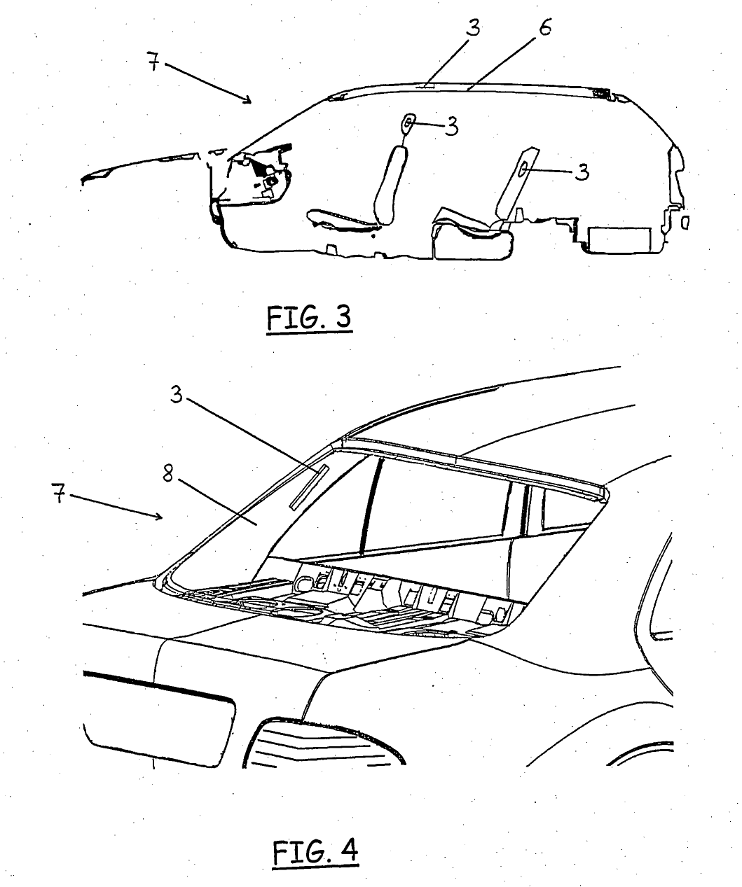

FIG. 3 shows an emergency call antenna 3 that is provided under a roof lining 6 of the vehicle 7 that is only shown schematically here. An emergency antenna 3 of this type in this case has a radiation characteristic that allows emergency call signals to be sent through the windows of the vehicle 6.

FIG. 4 shows an emergency call antenna 3 that is provided on the inside on a C-column 7 of the vehicle 6. Other columns, such as the A-column, the B-column or also supporting elements of the doors are also possible.

While the emergency call antennas 1 illustrated according to FIGS. 1 to 4 are only shown schematically, they are antennas that regarding their installation location, the frequency range and the radiation characteristic are adapted to a certain purpose (sending the emergency call signal). Possible designs for antennas of this type are first of all monopoles or dipoles, the configuration of the emergency call antenna as a low-profile antenna (flat design), a slot antenna or as a cavity resonator needing mention as a particularly advantageous embodiment.

### LIST OF REFERENCE NUMERALS

1. seat
2. headrest
3. antenna (emergency call antenna)
4. cabling
5. backrest
6. roof lining
7. vehicle

1. An antenna for use communicating in a vehicle, particularly in a passenger car, characterized in that the antenna is provided in the vehicle in a crash-protected location that allows the radiation of the antenna required for use communicating in the event of a crash.

2. The antenna according to claim 1, characterized in that the antenna is provided in a connecting brace between a roof and a body of the vehicle, particularly in a C-column.

3. The antenna according to claim 1, characterized in that the antenna is provided on the interior of the vehicle, particularly in a dashboard, in a roof lining, in a sun visor, in an inside door handle, in a seat, in a headrest, in an interior lining, in an armrest, in a center console or the like of the vehicle.

4. The antenna according to claim 1, characterized in that the antenna is mounted in an outside rear view mirror on the interior of the vehicle.

5. The antenna according to claim 1, characterized in that the antenna is mounted in the region of a roll bar in a vehicle that has a removable top.

6. The antenna according to claim 1, characterized in that the antenna is configured as a slot antenna.

7. The antenna according to any one of the preceding claims, characterized in that the antenna is configured as a cavity resonator.

8. The antenna according to any one of the preceding claims, characterized in that the antenna is configured as a low-profile antenna.
